(19) United States
(12) Patent Application Publication
(10) Pub. No.: US 2025/0166413 A1
(43) Pub. Date: May 22, 2025

(54) PROGRAM WHICH BEHAVES DIFFERENTLY DEPENDING ON FACIAL EXPRESSION OF USER

(71) Applicant: INTERMAN Corporation, Kagoshima (JP)

(72) Inventors: Shigeki UETABIRA, Kagoshima (JP); Yoshimasa SAITOH, Tokyo (JP)

(73) Assignee: INTERMAN Corporation, Kagoshima (JP)

(21) Appl. No.: 18/948,857

(22) Filed: Nov. 15, 2024

(30) Foreign Application Priority Data
Nov. 17, 2023 (JP) 2023-195586

(51) Int. Cl. G06V 40/16; G06V 10/82

(52) U.S. Cl. CPC G06V 40/174; G06V 10/82; G06V 40/172

(57) ABSTRACT

A new input method for computer-executed programs using AI technology. The program is executed on a computer equipped with an imaging device, which captures the user's facial expressions. In the computer, a facial expression recognition system is implemented that recognizes the expressions captured by the imaging device. The computer-executed program then behaves differently depending on facial expression of the user.

### CROSS-REFERENCE TO RELATED APPLICATIONS

The present application claims priority under 35 U.S.C. § 119 to Japanese Patent Application No. P2023-195586, filed on Nov. 17, 2023 including description, claims, drawings, and abstract. The contents of this application are herein incorporated by reference in their entirety.

### BACKGROUND

### Field of the Invention

The present invention relates to a program equipped with a new input method using AI technology.

In recent years, with the emergence of ChatGPT, interest in AI has increased rapidly. Consequently, investments related to AI have grown, leading to further advancements and expanded applications in various fields.

AI is also being utilized in diverse ways within the fields of games and entertainment. In particular, AI plays a crucial role in improving work efficiency in the field of game development. For example, game developers can use AI generators to instantly create images by inputting text prompts (brief descriptions of what they want to visualize).

There are also technologies where AI is directly involved in the actual content of games. These include character AI, which allows in-game characters to act autonomously, and meta AI, which oversees the game as a whole from a top-down perspective, controlling the appearance of enemy characters and changes in the game environment based on the player's movements.

However, conventional AI technologies for games have rarely applied AI to the player interface. Most gamers play games exclusively using traditional controllers such as joysticks or gamepads.

Furthermore, US2010194762A1 discloses a system that captures user gestures as input for games and other applications. This system analyzes gestures by obtaining depth information from scattered light pulse imaging, and requires a specialized device.

Therefore, it is an object of the present invention to provide a new means of inputting information into a program executed on a computer by utilizing AI technology.

### SUMMARY

To achieve at least one of the above-mentioned objects, reflecting one aspect of the present invention, a program executed in a system comprises a computer, a display device, and an imaging device that captures an image of a face of a user, wherein the program is executed by the computer in a different manner depending on facial expression of the user which is recognized with reference to the image captured by the imaging device.

In accordance with a preferred embodiment of the present invention, the recognized facial expression of the user is classified into a plurality of emotions by a convolutional neural network.

Furthermore, in accordance with a preferred embodiment of the present invention, the program is a game program which accepts the recognized facial expression of the user as an input.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a perspective view showing a flight simulator 1 that uses a program according to an embodiment of the present invention.

FIG. 2 is a diagram explaining the principle by which a display screen of a curved display 20 forms an aerial image G via an optical plate 40 in the flight simulator of the embodiment of the present invention. This figure shows only the optical plate 40, the display screen of the curved display 20, and the aerial image G as viewed from the left side of the flight simulator 1.

FIG. 3 is a diagram explaining the principle by which the display screen of the curved display 20 forms the aerial image G via the optical plate 40 in the flight simulator of the embodiment of the present invention. This figure shows only the optical plate 40, the display screen of the curved display 20, and the aerial image G as viewed from directly above the flight simulator 1.

FIG. 4 is a diagram explaining the principle by which the display screen of the curved display 20 forms the aerial image G via the optical plate 40 in the flight simulator of the embodiment of the present invention. This figure shows only the optical plate 40, the display screen of the curved display 20, and the aerial image G as viewed from the front of the flight simulator 1.

FIG. 5 is a block diagram illustrating the architecture of a convolutional neural network implemented in the program of the embodiment of the present invention.

FIG. 6 shows the screen display when flying with a smiling expression in the flight simulator implemented by the program of the embodiment of the present invention.

FIG. 7 shows the screen display when flying with a stern expression in the flight simulator implemented by the program of the embodiment of the present invention.

### DETAILED DESCRIPTION

Hereafter, with reference to the accompanying drawings, an embodiment of a program according to the present invention will be described. Here, the technology is applied to a flight simulator, where a user (hereinbelow, called the pilot) can sit in a replica cockpit and operate an aircraft while watching video, experiencing full-scale piloting.

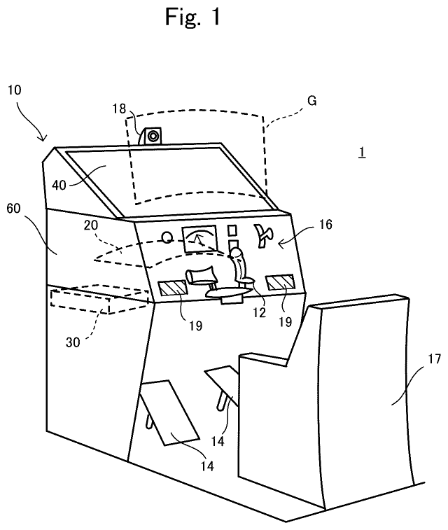

As shown in FIG. 1, the flight simulator 1 is a replica cockpit that imitates the cockpit of an aircraft, and consists of a simulator main body 10 and a seat 17 for the pilot who controls the flight simulator 1. The simulator main body 10 is equipped with a control stick 12, control pedals 14, instruments 16, a camera 18, speakers 19, and the like.

Inside the simulator main body 10, a curved display 20, a control device 30, and an optical plate 40 are installed. The control device 30 is connected to the control stick 12, the control pedals 14, the instruments 16, the camera 18, the curved display 20, etc. via internal wirings (not shown in the figure), and exchanges signals with these devices to simulate flight conditions to provide a boarding experience.

The optical plate 40 faces the display surface of the curved display 20 at a certain angle (for example, 45 degrees) with the incident surface facing downward. The image on the display surface of the curved display 20 is focused again at a symmetrical position on the opposite side of the optical plate 40, forming an aerial image G that is identical to the original. In other words, it can be said that the aerial display G is constructed at the image-forming position in the air.

Of course, the image displayed on the curved display 20 is the flight image (background, aircraft, etc.) generated by the flight simulator 1. The specific implementation of the flight control simulation and the like performed by the flight simulator 1 here is similar to that of conventional flight simulators, except for the control based on the image from the camera 18 described below, so a detailed explanation will be omitted here.

The curved display 20 is a curved liquid crystal display device having a convex display surface that is placed substantially horizontally and facing upward. Here, for example, the curvature of the convex display surface is 1000R. Instead of a curved liquid crystal display device, a flexible display made from an organic EL display or electronic paper with a backlight and bent at the desired curvature may be used. In any case, the display surface faces upward and is convex upward.

Although the position of the curved display 20 is fixed here, the supporting structure may be designed to allow the position to be adjusted vertically. In this case, the focal point of the aerial image G can be adjusted to a position that is easy for the operator (pilot) to view.

The control device 30 is essentially a small computer and is composed of a CPU (Central Processing Unit), a ROM (Read Only Memory), a RAM (Random Access Memory), a storage device for storing various programs and data, an input/output interface, and the like. As the input/output interfaces, for example, a USB port and a wireless LAN such as WIFI are implemented. Via this input/output interface, it is possible to access various data related to the flight simulation, update programs, and download trained convolutional neural network models (described below). The control device 30 outputs video signals to the curved display 20, displaying an image to form an aerial image, and also outputs drive signals to the speaker 19 to reproduce a sound field synchronized with the image on the curved display 20.

The optical plate 40 can be a retro-transmitting optical imaging element (transmissive dihedral corner reflector array) as described in Japanese Patent Published Application No. 2011-175297. This optical imaging element is achieved by arranging numerous light-reflecting planes orthogonal to each other in a regular pitch. Alternatively, a structure such as the two-sided corner reflector with reflective surfaces formed on the sides of square holes, as described in Japanese Patent No. 4900618, can also be used.

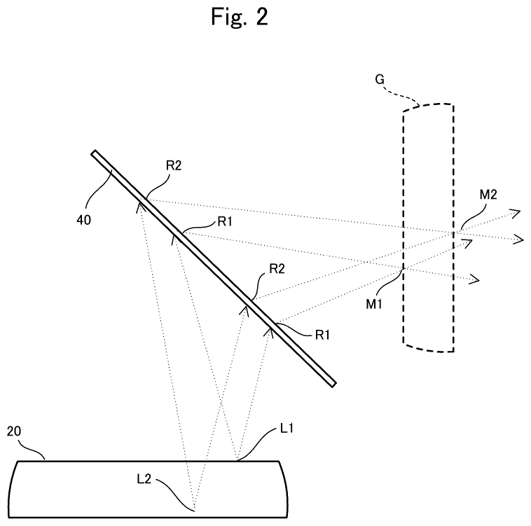

FIG. 2 is a diagram explaining the principle by which the display screen of the curved display 20 forms the aerial image G via the optical plate 40. For simplicity of explanation, this figure shows only the optical plate 40, the display screen of the curved display 20, and the aerial image G as viewed from the left side of the flight simulator 1.

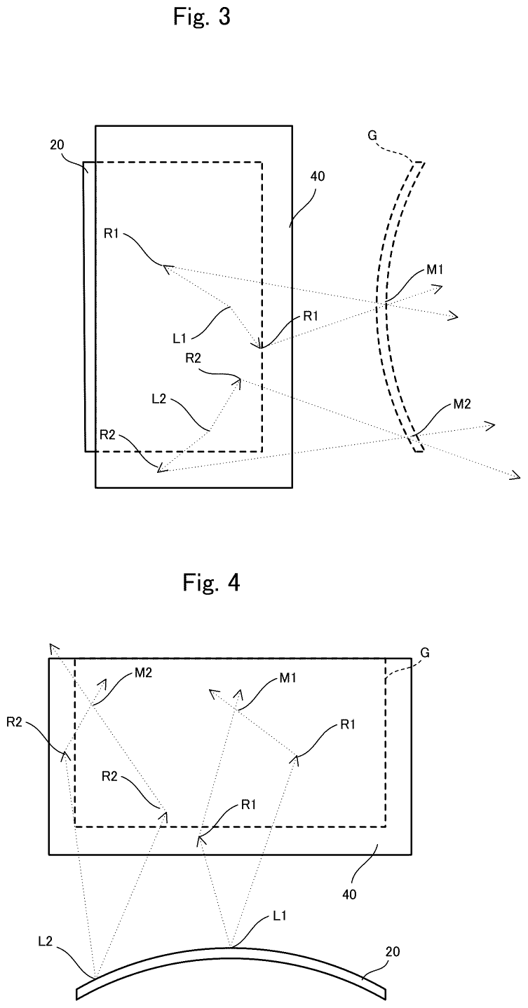

FIG. 3 is also a diagram explaining the principle by which the display screen of the curved display 20 forms the aerial image G via the optical plate 40. For simplicity of explanation, this figure shows only the optical plate 40, the display screen of the curved display 20, and the aerial image G as viewed from directly above the flight simulator 1.

Furthermore, FIG. 4 is also a diagram explaining the principle by which the display screen of the curved display 20 forms the aerial image G via the optical plate 40. For simplicity of explanation, this figure shows only the optical plate 40, the display screen of the curved display 20, and the aerial image G as viewed from the front of the flight simulator 1 (i.e., behind the seat 17 in FIG. 1).

Under certain conditions of incident light, the optical plate 40, with a dual reflection structure such as a two-plane orthogonal reflector or a two-plane corner reflector, retro-reflects incident light with respect to the panel plane direction while maintaining the component normal to the panel plane (retro-transmission).

FIG. 2 will be referred to. In the coordinate system (x, y, z), the x direction is the paper surface direction along the optical plate 40 (i.e., the 45-degree direction connecting the upper left and lower right of the paper), the z direction is the direction perpendicular to the surface of the optical plate 40 (i.e., the 45-degree direction connecting the upper right and lower left of the paper), and the y direction is the direction perpendicular to the surface of the paper (i.e., the direction penetrating the paper at a right angle). Here, the incident light vector (vx, vy, vz) before entering the optical plate 40 is retro-transmitted through the optical plate 40 and becomes the exiting light vector (−vx, −vy, vz).

Thus, the mirror image will be formed as an actual image on the opposite side of the optical plate 40. As a result, the display screen of the curved display 20 and the aerial image G are plane symmetrical with respect t the optical plate 40.

In other words, a central position L1 in the horizontal direction of the curved display 20 (the most protruding point) is close to the optical plate 40, and the light emitted from the position L1 converges at a position M1, which is close to the optical plate 40. That is, the light emitted from the position L1 is reflected at arbitrary positions R1, R1 on the optical plate 40, and is focused at the position M1, which is located on the opposite side of the optical plate 40 and is the same distance as the distance between the position L1 and the optical plate 40.

Similarly, a position L2 on the lateral outer side of the curved display 20 is more spaced from the optical plate 40 than the position L1, and light emitted from position L2 is focused at a position M2 more spaced from the optical plate 40 than the position M1. In other words, the light emitted from the position L2 is reflected at arbitrary positions R2, R2 of the optical plate 40 and focused at the position M2, which is as far away from the optical plate 40 as the distance between the position L2 and the optical plate 40, on the opposite side of the plate.

As a result, to the pilot sitting in seat 17, the aerial image G displayed in front of him appears concavely curved, and the concave curved aerial display is implemented floating in the air.

In conventional flight simulators using flat displays, the left and right edges of the display appear far away from the pilot and difficult to see, and images at the edges become distorted, increasing the difference from the natural field of view. However, with the concave curved aerial display, the pilot's field of view as seen during actual flight can be faithfully reproduced without any sense of incongruity.

Additionally, since the aerial display physically lacks a display surface and a bezel, it enhances the sense of three-dimensionality, delivering a more immersive piloting experience. Furthermore, with a conventional physical display, external light can inevitably be reflected off the display surface, obstructing the pilot's view, but with an aerial display, such reflection of external light is not possible, allowing for a deeply immersive simulated piloting experience without being hindered by external light.

Furthermore, the camera 18 plays an important role in the present invention. The camera 18 is located in front of the flight simulator 1 and captures the face of the pilot sitting in the seat 17. The video footage of the pilot's face captured by the camera 18 is transmitted to the control unit 30 on a real time base during the operation of the flight simulator 1.

In this flight simulator 1, the weather changes based on the facial expression of the pilot captured by the camera 18. The pilot can intentionally modify the facial expression to change the weather to match his or her intentions. On the other hand, when the pilot is flying, the emotion and awareness of the pilot may unintentionally be displayed on their face, causing the weather to change regardless of the thought of the pilot.

The image data of the pilot's face captured by the camera 18 is sent to the control unit 30. The control unit 30 is equipped with a facial expression recognition system that recognizes facial expressions, typically emotions such as anger, disgust, fear, happiness, sadness, surprise, and neutrality.

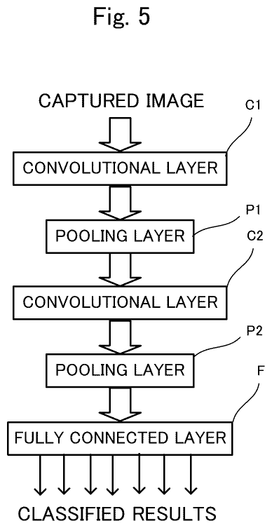

This facial expression recognition system is implemented using a Convolutional Neural Network (CNN), a popular deep learning method. The CNN architecture is shown in FIG. 5. The CNN consists of a first convolutional layer C1, a first pooling layer P1 that receives the output of the first convolutional layer C1, a second convolutional layer C2 that receives the output of the first pooling layer P1, a second pooling layer P2 that receives the output of the second convolutional layer C2, and a fully connected layer F that receives the output of the second pooling layer P2. In this case, the convolutional and pooling layers are connected in two stages, but additional stages can be added.

The image data of the pilot's face captured by the camera 18 is input into the first convolutional layer C1. However, this image data is resized to fit the first convolutional layer C1 and converted to grayscale before being input into the first convolutional layer C1. The image data is a two-dimensional array, and such multidimensional arrays are sometimes referred to as tensors.

In the first convolutional layer C1, an inner product of a kernel, which is a small two-dimensional array (e.g., 9×9), and a partial region (window: e.g., 9×9) of the same size of the input image data is calculated to obtain an output. This inner product is performed while sliding the window across the entire input image data, and as a result, the output becomes two-dimensional array data. Each parameter of the kernel is optimized in advance through learning so as to extract the features of the input image data. Multiple kernels (e.g., 16) are used, resulting in multiple sets of outputs. However, instead of outputting the inner product results directly, they are nonlinearized using an activation function. In this case, the activation function used is ReLU( ), which sets any negative values of the inner product calculation result to 0.

The output from the first convolutional layer C1 is input into the first pooling layer P1. The first pooling layer P1 performs a downsampling operation that retains only the representative value (typically the maximum value) within a local spatial range (e.g., 2×2). By thinning out and compressing the output of the first convolutional layer C1, there are the advantage of not only reducing noise and minor misalignments in the image but also significantly reducing the computational load.

The output from the first pooling layer P1 is input into the second convolutional layer C2, followed by activation with ReLU( ) and input into the second pooling layer P2. The second convolutional layer C2 and the second pooling layer P2 have an architecture similar to that of the first convolutional layer C and the first pooling layer P1 but have different sizes, and the kernels and the like are optimized separately.

The output from the second pooling layer P2 is input into the fully connected layer F. As described below, in this embodiment, facial expressions are classified into seven categories (emotions). Therefore, the fully connected layer F, which serves as the output layer, contains seven units (neurons). Each neuron is connected to all the outputs of the second pooling layer P2. The output of the second pooling layer P2 is denoted by pj (j=1 to M), and the output of each neuron Ni (i=1, 2, . . . , 7) is calculated as follows:

Ni=bi+wi1·p1+wi2·p2+ . . . +wiM·pM

In the above formula, bi represents the bias and wij represents the weights.

Furthermore, to express the output Ni as the probability for each category (so that the sum of all outputs equals 1), the following softmax function is calculated to obtain the final probability value Ei.

Ei=e^{Ni}/(e^{N1}+e^{N2}+ . . . +e^{N7})

The values of each parameter of the CNN are pre-optimized through learning methods such as backpropagation. The parameters and pre-trained models can be downloaded through the internet to update the facial expression recognition system as needed.

In this embodiment, facial expressions are classified into seven categories: anger, disgust, fear, happiness, sadness, surprise, and neutrality. The recognition results are expressed as probabilities for each category. Depending on the program applied to the present invention, all seven categories and their probabilities can be used, or only a subset may be used.

In the implementation of the flight simulator 1, weather is calculated based on the seven categories and their probabilities. Weather parameters include cloud cover, precipitation, snowfall, wind direction, wind speed, humidity. Additional parameters such as wind variation, gustiness, turbulence (airflow instability), and vertical airflows can also be included. Furthermore, settings for cumulonimbus clouds or storms may be incorporated. Weather control is performed based on the selected parameters and facial expressions.

For example, facial expression recognition system outputs (probabilities) can be used as follows to calculate weather parameters, with anger as E1, disgust as E2, fear as E3, happiness as E4, sadness as E5, surprise as E6, and neutrality as E7:

Cloud cover (%)=MIN(100,10+150×(1−E4−E7))

Precipitation (mm)=MAX(0,10×(2×E1+3×E2+E3+2×E5)−2)

Wind variation (%)=100×(E1+E2+E3+E5+E6)

Wind speed (m/s)=10×E1+10×E2+15×E3+E4+2×E6

Turbulence (%)=10×(5×E1+5×E2+10×E3+5×E6)

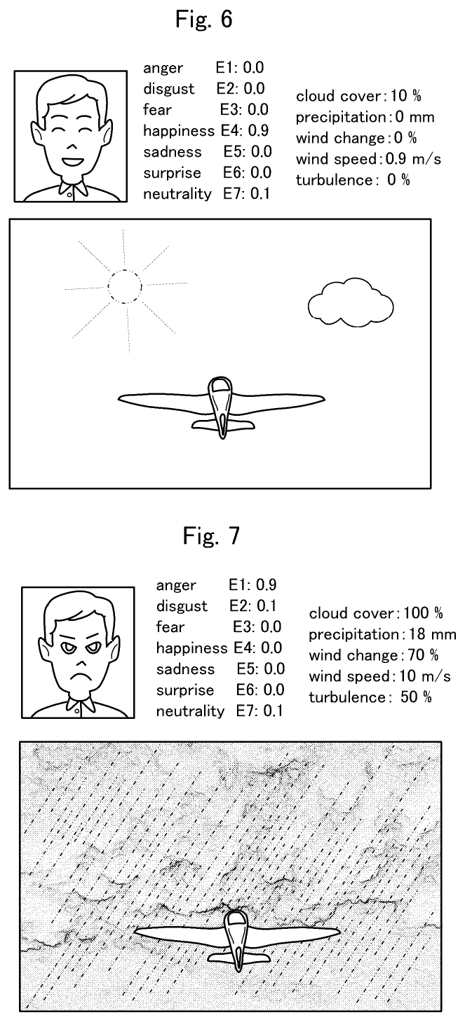

These settings are used as environmental variables when executing the flight simulation program in the flight simulator 1, allowing the pilot's emotions to be reflected in the weather during the simulation. Alternatively, the pilot can change the weather to his/her liking by adjusting the facial expression. For example, if you want to enjoy a leisurely flight under a clear sky, you should fly with a cheerful expression (FIG. 6), but if you want to feel the thrill in bad weather, you should fly with a stern expression (FIG. 7).

According to the program related to the present invention, an application that implements a new input method for computer-executed programs using AI technology is realized without the need for special input devices. As a result, users can experience something entirely new and refreshing.

The foregoing description of the embodiments has been presented for purposes of illustration and description. It is not intended to be exhaustive or to limit the invention to the precise form described, and obviously many modifications and variations are possible in light of the above teaching. The embodiment was chosen in order to explain most clearly the principles of the invention and its practical application thereby to enable others in the art to utilize most effectively the invention in various embodiments and with various modifications as are suited to the particular use contemplated.

In the above example, the application to a flight simulator simulating a cockpit has been demonstrated, but the application of the present invention is not limited to this. For example, the present invention may be applied to a game program executed on a personal computer equipped with a normal Web camera. As one example, in a fighting game, when the “anger” facial expression is recognized, the attack power could increase. In this case, in addition to traditional controller skills, facial expression performance becomes part of the competition, doubling the fun.

Moreover, in the above embodiment, two alternating sets of convolutional and pooling layers are implemented for the convolutional neural network that recognizes facial expressions, but the present invention is not limited to this configuration. For example, the convolutional layers could be increased to three, and pooling layers could be partially combined. Furthermore, it is also possible to layer multiple fully connected layers.

Furthermore, to further develop the spirit of the present invention, sensors could be installed to detect changes in the user's biological information (such as heart rate, body temperature, muscle tension, brainwaves, or breathing), and the program's processing could change in response to these variations. Needless to say, it is also possible to combine these user's biological information and the facial expressions. For instance, in a fighting game, muscle stiffness in the arms and intense facial expressions could charge an energy ball.

What is claimed is:

1. A program executed in a system, comprising: a computer, a display device, and an imaging device that captures an image of a face of a user, wherein the program is executed by the computer in a different manner depending on facial expression of the user which is recognized with reference to the image captured by the imaging device.

2. The program according to claim 1, wherein the recognized facial expression of the user is classified into a plurality of emotions by a convolutional neural network.

3. The program according to claim 2, wherein the program is a game program which accepts the recognized facial expression of the user as an input.
